(19) United States
(12) Patent Application Publication
(10) Pub. No.: US 2024/0042826 A1
(43) Pub. Date: Feb. 8, 2024

(54) VEHICULAR INTERIOR REARVIEW MIRROR ASSEMBLY WITH CABIN AIR QUALITY SENSOR

(71) Applicant: Magna Mirrors Holding GmbH, Sailauf (DE)

(72) Inventors: Sethuraman Ravichandran, Aschaffenburg (DE); Peter Krebs, Moembris (DE)

(21) Appl. No.: 18/358,273

(22) Filed: Jul. 25, 2023

Related U.S. Application Data
(60) Provisional application No. 63/371,534, filed on Aug. 16, 2022.
(60) Provisional application No. 63/369,431, filed on Jul. 26, 2022.

(51) Int. Cl. B60H 1/00; B60R 1/12; B60R 1/04

(52) U.S. Cl. CPC B60H 1/00742; B60R 1/12; B60R 1/04; B60R 2001/1223

(57) ABSTRACT

A vehicular cabin monitoring system includes a carbon dioxide sensing device disposed at a vehicular component of a vehicle. The carbon dioxide sensing device captures sensor data representative of a sample of air at the vehicular component. The cabin monitoring system, based on processing at an ECU of sensor data captured by the carbon dioxide sensing device, determines a carbon dioxide level at the interior portion of the vehicle. The cabin monitoring system, when the vehicle is parked and not operating and based on the determined carbon dioxide level at the interior portion of the vehicle, determines occupancy of the vehicle. The cabin monitoring system, when the vehicle is operating and based on the determined carbon dioxide level at the interior portion of the vehicle, controls a heating, ventilation, and air conditioning (HVAC) system of the vehicle.

### CROSS REFERENCE TO RELATED APPLICATIONS

The present application claims the filing benefits of U.S. provisional application 63/371,534, filed Aug. 16, 2022, and U.S. provisional application Ser. No. 63/369,431, filed Jul. 26, 2022, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

A vehicular cabin monitoring system includes an air sensing device disposed at a vehicular component disposed at an interior portion of a vehicle equipped with the cabin monitoring system. For example, the air sensing device may be disposed at an interior rearview mirror assembly of the vehicle. The carbon dioxide sensing device captures sensor data representative of a sample of air at the vehicular component. An electronic control unit (ECU) includes electronic circuitry and associated software, including a data processor configured to process sensor data captured by the air sensing device. The system, based on processing at the ECU of sensor data captured by the air sensing device, determines a carbon dioxide level at the interior portion of the vehicle. When the vehicle is not operating (i.e., the vehicle is parked and turned off), the system determines occupancy of the vehicle based on the determined carbon dioxide level at the interior portion of the vehicle. When the vehicle is operating (i.e., the vehicle is turned on), the system controls a heating, ventilation, and air conditioning (HVAC) system of the vehicle based on the determined carbon dioxide level at the interior portion of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a perspective view of a vehicle equipped with a cabin monitoring system that includes a carbon dioxide sensing device at an interior rearview mirror assembly of the vehicle;

FIG. 3 is a schematic view of the cabin monitoring system; and

FIG. 4 is a flowchart of a method of controlling a heating, ventilation, and air conditioning (HVAC) system of the vehicle based on carbon dioxide levels measured by the carbon dioxide sensing device.

### DESCRIPTION OF THE PREFERRED EMBODIMENTS

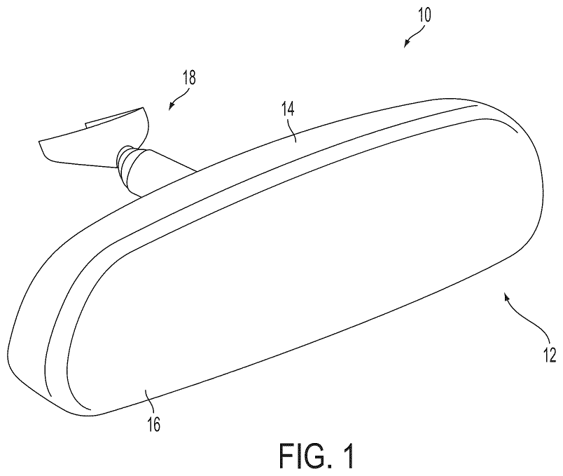

Referring now to the drawings and the illustrative embodiments depicted therein, an interior rearview mirror assembly 10 for a vehicle includes a mirror head 12 that includes a mirror casing 14 and a mirror reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or base or mounting configuration or assembly 18. The interior rearview mirror assembly 10 may include any suitable construction. For example, the interior rearview mirror assembly 10 may include a variable reflectance electro-optic mirror reflective element 16 or the mirror assembly 10 may include a prismatic reflective element 16. Optionally, the interior rearview mirror assembly may comprise a dual-mode interior rearview video mirror that can switch from a traditional reflection mode to a live-video display mode.

Modern vehicles include an increasing number of safety measures, including occupancy monitoring systems, to alert drivers to children and pet animals left behind in parked vehicles. Leaving children and animals unattended in parked vehicles can be dangerous as temperature levels inside the vehicle cabin may rise rapidly when the vehicle is turned off and parked in sunny and hot weather conditions or temperature levels inside the cabin may fall rapidly in cold weather conditions. Typically, vehicle occupancy may be detected by using weight sensors in seats, buckle based reminder systems that determine when a seat belt is buckled, or by processing sensor data captured by cameras, radars, or ultrasonic sensors viewing the inside of the cabin of the vehicle. Traditional methods of determining occupancy, and in particular determining occupancy based on imaging sensors, have disadvantages, such as user privacy issues (e.g., data protection), high consumption level of energy and data processing resources, limited field of view of the sensors, and detection accuracy.

As described further below, the cabin monitoring system includes a sensor configured to determine presence and concentration levels of carbon dioxide (CO2) at the interior portion of the vehicle and, based on determined levels of CO2 within the vehicle, determines occupancy of the vehicle. CO2 is a valuable indicator of the presence of occupants in the vehicle as both animals and humans release CO2 when breathing and the CO2 remains in the vehicle when the windows and doors are closed. Levels of CO2 can increase by about 20 parts per million (ppm) per minute when a person is in the vehicle. By checking the CO2 levels at regular intervals, such as about every 20 seconds, it can be determined whether someone is in the vehicle, such as within one minute or less. Thus, the system can determine whether a child or animal has been left in the vehicle after the vehicle is parked and turned off and trigger an alert if presence of a person or animal is determined. This system utilizes less processing and energy resources than a traditional, camera-based occupancy monitoring system and thus does not significantly drain the power sources of the vehicle when the vehicle is parked and turned off. When the vehicle is turned on, the cabin monitoring system may determine the CO2 levels at the interior cabin of the vehicle to control a climate control system of the vehicle, such as to enable or activate and disable or deactivate air recirculation.

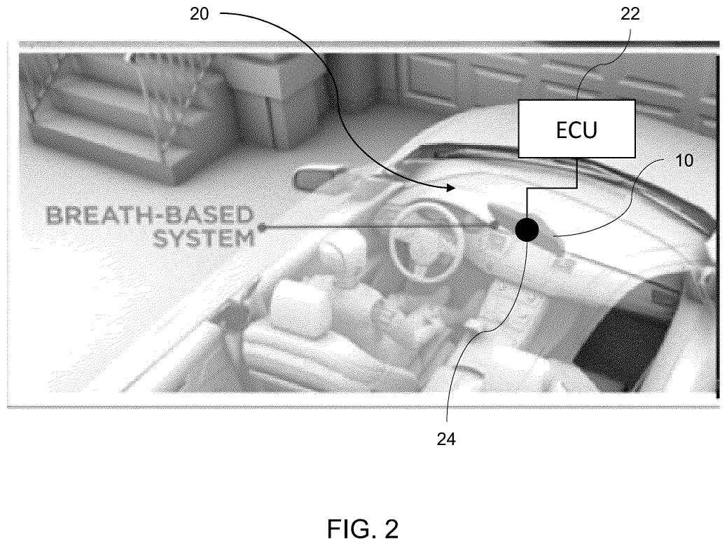

Referring to FIG. 2, the cabin monitoring system 20 includes an electronic control unit (ECU) 22 including electronic circuitry and associated software, where the electronic circuitry includes a data processor configured to process sensor data captured by a CO2 sensing device 24. The ECU 22 may be disposed at the mirror assembly 10 (such as into the mirror head or the mounting structure) or at any suitable position elsewhere at the vehicle and electrically connected or in electrical communication with circuitry of the mirror assembly or mirror head. The ECU 22 is in communication (such as via a communication network of the vehicle, such as a LAN or CAN bus of the vehicle) with an ignition or starting system or other vehicle control so that, when the vehicle is turned off (e.g., the ignition or engine of the vehicle is turned off and the vehicle is not operating or operation of the vehicle is disabled), the ECU 22 may begin processing sensor data captured by the CO2 sensing device 24 to determine CO2 levels within the vehicle and detect presence or absence of occupants inside the vehicle. When the vehicle is turned on (e.g., the ignition or engine of the vehicle is turned on and the vehicle is operating or operation of the vehicle is enabled), the ECU 22 may process sensor data captured by the CO2 sensing device 24 to determine CO2 levels within the vehicle, such as to control the climate control system (i.e., a heating, ventilation, and air conditioning (HVAC) system) of the vehicle. The data processor may be part of the same or common ECU as the vehicle control and/or climate control, or the data processor and vehicle control and/or climate control may be at separate ECUs.

The CO2 sensing device 24 receives or captures a sample of air from within the interior cabin of the vehicle and the system processes the sample of air to determine a CO2 level of the sample, which may be representative of a CO2 level of the interior of the vehicle. The CO2 sensing device 24 may utilize aspects of the known CO2 sensing devices. For example, the CO2 sensing device 24 may be a nondispersive infrared (NDIR) sensor that includes an infrared (IR) light emitter or IR light source, an IR detector, and an optical chamber that allows ambient air to pass in front of an optical filter. The IR light source emits a continuous beam of IR light inside the optical chamber and the detector measures the amount of IR light that passes through the optical filter. As the IR light passes along the length of the optical chamber, CO2 gas absorbs a specific band of IR light and allows the remaining wavelength to pass through the optical filter. The IR detector measures the remaining amount of IR light and determines the amount of IR light absorbed, which is proportional to the concentration of CO2 in the sample of air within the optical chamber.

In the illustrated embodiment, the CO2 sensing device 24 is disposed at the interior rearview mirror assembly 10, such as at a rear surface of the mirror casing of the mirror head, so that the sensing device 24 may be in fluid communication with the ambient air of the cabin at a central location of the cabin. The mirror casing may include one or more ports or passageways or conduits or vents and the CO2 sensing device 24 is disposed within the mirror head and in communication with the passageway to receive the air sample through the mirror casing. Optionally, the mirror casing may include guide structure (such as a tapered funnel or the like) to direct the air sample toward the sensing device 24. Optionally, the sensing device 24 may be disposed at any suitable location within the vehicle, such as at an overhead console or a windshield mounted electronics module or integrated with the HVAC system of the vehicle (such as at an air intake of the HVAC system).

The system may passively monitor air samples from the interior cabin of the vehicle, such that the CO2 sensing device 24 captures or measures the air sample as unassisted air flow in the cabin causes the air sample to flow through the mirror casing port and toward the CO2 sensing device 24. That is, the one or more ports or conduits may always be in communication with the air inside the vehicle and, as air circulates throughout the vehicle, the CO2 sensing device 24 may constantly or episodically determine a CO2 level to determine whether an occupant is present in the vehicle. Optionally, the system actively capture samples from the vehicle cabin, such that the mirror casing may include a collection device, such as a fan or suction device, that is operated to direct the sample of air to the CO2 sensing device 24.

When the vehicle is parked and not running/operating (i.e., a parking gear of the vehicle gear selector is selected and operation of the vehicle is disabled), the cabin monitoring system 20 performs an occupant monitoring function for a period of time following parking of the vehicle. That is, the system 20 processes sensor data captured by the CO2 sensing device 24 to determine whether an occupant is present in the vehicle after the vehicle is parked and turned off. The system 20 may determine the CO2 level within the vehicle at regular intervals, such as intervals of 20 seconds or 15 seconds or less, and compare consecutive measurements to find a slope (rate of increase or decrease) of the CO2 level. In other words, the system 20 compares measurements over time to determine whether the CO2 levels in the vehicle are rising, falling, or remaining constant. If the system determines that the CO2 levels are rising in the vehicle, the system determines that an occupant is present in the vehicle and issues an alert (e.g., activates an alarm of the vehicle or flashes the vehicle lights or sends an alert/message to the user's (e.g., vehicle owner, driver, etc.) smart phone or the like). If the system determines that the CO2 levels are falling or remaining constant, the system determines that no occupant is present in the vehicle (i.e., absence of an occupant) and (after the sampling time period, such as one minute or two minutes or three minutes after the vehicle is parked, is completed) stops capturing and/or processing sensor data to preserve power while the vehicle is parked.

To determine presence of an occupant while avoiding false determinations, the system may only determine presence of an occupant when CO2 levels are determined to have increased for a threshold period of time, or that CO2 levels have increased by a threshold amount. For example, the system 20 may determine a set of CO2 measurements (e.g., six data points, N0-N5), each measurement of the set of CO2 measurements representative of the CO2 level within the vehicle at a respective point in time and separated from another measurement by a given time interval. Once the set of CO2 measurements is determined, the system performs comparisons on consecutive measurements of the set to determine if the CO2 level increased between measurements (e.g., six data points would provide five comparisons of consecutive data points, such as N1-N0, where a negative result indicates a decrease in CO2 and a positive result indicates an increase in CO2). Optionally, the system may compare any data point from the set of CO2 measurements to any earlier data point to determine whether the CO2 levels have changed between measurements.

The system may only determine presence of an occupant where a threshold number of comparisons indicate increases in CO2 levels (e.g., the system may require that four or more comparison results indicate an increase in CO2) and/or where the determined increases in CO2 levels are greater than a threshold increase between the CO2 measurements. In other words, the system determines presence of an occupant responsive to determination that consecutive CO2 measurements indicate an increase in CO2 within the vehicle cabin that is greater than a threshold amount and where the CO2 measurements indicate the increase for at least a threshold number of measurements. Further, the system may determine presence of an occupant where the set of CO2 measurements indicates an overall increase in CO2 that is greater than a threshold amount. For example, the system may determine presence of the occupant based on the measured CO2 increase being greater than the threshold increase even if the rising level of CO2 was not determined for the threshold number of consecutive measurements.

Similarly, the system may only determine absence of an occupant where a threshold number of comparisons indicate decreases or stability of CO2 levels (e.g., the system may require that four or more comparison results indicate a decrease or little to no change in CO2). That is, the system determines absence of an occupant responsive to determination that consecutive CO2 measurements indicate a decrease in CO2, the same amount of CO2, or an increase in CO2 within the vehicle that is less than a threshold amount, and where the CO2 measurements indicate the decrease in CO2, the same amount of CO2, or the limited increase in CO2 for a threshold number of measurements.

Optionally, if any number of comparisons less than the threshold indicates a CO2 increase, the system may capture and process additional sets of data points until presence or absence of the occupant is determined with a threshold level of confidence. Optionally, the system may capture and compare CO2 measurements on a running basis and determine presence or absence of an occupant based on a threshold number of consecutive comparisons indicating presence or absence.

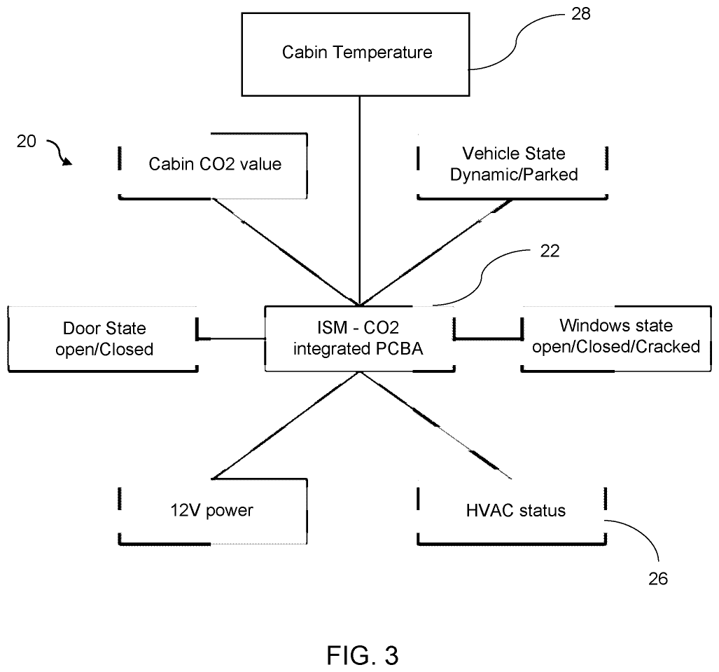

To further prevent false determinations, the system 20 may only perform the occupant monitoring function when a set of vehicle conditions are satisfied, such as that the vehicle is parked, the doors and windows are closed, and the engine or propulsion system or HVAC system is turned off. Thus, and as shown in FIG. 3, the cabin monitoring system 20 receives signals from the gear selector of the vehicle, a system that determines the state of the windows, the HVAC system 26, a power source of the vehicle, and a system that determines the state of the doors. For example, a driver may leave a dog unattended in the vehicle for a short time and roll the windows down to allow cool air to enter the vehicle. In such an example, because the windows are rolled down, the system would likely not detect an increase in CO2, nor would the driver want the cabin monitoring system to trigger an alarm, and the system 20 would not provide the occupant monitoring function.

Furthermore, the system 20 may monitor the temperature in the vehicle (such as via a temperature sensor 28 disposed inside the cabin of the vehicle) and only trigger the alert indicating presence of the occupant in the parked vehicle if the temperature in the vehicle satisfies a condition. For example, the system 20 may only issue the alert if an occupant is determined to be present in the vehicle and (i) if the temperature in the vehicle is above a first threshold temperature (that may indicate high temperatures or extreme heat), (ii) if the temperature in the vehicle is below a second threshold temperature (that may indicate low temperatures or extreme cold), of (iii) if a rate of change of the temperature in the vehicle indicates a rapidly increasing or decreasing temperature (that may indicate that the temperature in the vehicle could reach a dangerous level in a short amount of time). Thus, the system may determine the presence of an occupant in the vehicle (via sensing of CO2 levels) and only trigger the alert indicating presence of the occupant if sensor data captured by the temperature sensor 28 indicates that the temperature is at or could reach a dangerous or life-threatening temperature. A false or premature alert without significant danger to life could be irritating for the user, especially if the user intended to leave the occupant in the vehicle.

Optionally, such as to save processing power, the cabin monitoring system 20 may only process sensor data to determine the CO2 levels inside the cabin of the vehicle if the system first determines that the temperature inside the cabin is at or near a dangerous level. That is, the system may begin processing sensor data captured by the CO2 sensing device 24 to determine presence of the occupant responsive to the temperature within the vehicle satisfying the condition. Thus, the system may monitor the temperature inside the cabin of the vehicle and, responsive to determining that the temperature is at or near or approaching one of the threshold levels (e.g., indicating extreme heat or cold), the system may begin processing sensor data captured by the CO2 sensing device 24 to determine if an occupant is present in the cabin at the dangerous temperature level. The threshold temperatures (i.e., the high and/or low temperatures at which the system will perform occupant monitoring and trigger an alert if presence of an occupant is determined) may be set by a user (such as via input at a button or display of the vehicle or a mobile device of the user) or may be predetermined or preset by the vehicle manufacturer.

When the vehicle is operating or being driven, the cabin monitoring system 20 monitors the CO2 levels within the vehicle to adjust control of the HVAC system 26 of the vehicle. For example, the HVAC system 26 may have an air recirculation feature where, when activated, the HVAC system 26 recirculates the air inside the cabin and, when not activated, the HVAC system 26 draws air from exterior the vehicle and conditions the drawn air to circulate within the cabin. When the recirculation feature is activated, the HVAC system 26 may conserve energy because the recirculated air requires less cooling or heating to maintain a desired cabin temperature than if the air was drawn from the environment. The recirculation feature also allows the HVAC system 26 to reach and maintain a desired temperature within the cabin in a shorter amount of time. However, when the recirculation feature is activated, fresh air is not drawn from the environment and CO2 levels may rise within the vehicle. For example, with a single person in the confined space of the vehicle cabin CO2 levels may reach 2,000 ppm or greater in as little as 8 minutes. High levels of CO2 within the vehicle may lead to drowsiness for the driver or other negative health effects.

Thus, when the vehicle is in operation (i.e., a driving mode), the cabin monitoring system 20 monitors the CO2 levels of the vehicle cabin and controls operation of the HVAC system 26 to enable or disable (and optionally, active or deactivate) the recirculation feature. For example, if the determined level of CO2 within the vehicle is greater than a first threshold level (such as 600 ppm, 700 ppm, 1500 ppm, or greater), the cabin monitoring system 20 may disable the recirculation feature of the HVAC system 26. In other words, if the recirculation feature is currently on or activated and the CO2 levels are elevated, the system will turn off or deactivate the recirculation feature, and if the recirculation feature is not on or activated and the CO2 levels are elevated, the system will preclude the recirculation feature from being turned on or activated (and optionally the system may activate the HVAC to draw fresh air into the cabin). The system 20 may disable or deactivate the recirculation feature until the CO2 levels reach a second, lower threshold (such as 600 ppm, 700 ppm, or less). Further, when the vehicle is operating and the system determines that the CO2 levels within the vehicle are less than a threshold CO2 level, the system may activate the recirculation feature (such as to conserve energy). Thus, when CO2 levels within the vehicle are low, the system may activate the recirculation feature to conserve energy and, if CO2 levels rise within the vehicle, the system may deactivate or disable the recirculation feature until the CO2 levels fall to an acceptable level, at which time the recirculation feature may be enabled or reactivated. Therefore, when the vehicle is in operation, the cabin monitoring system 20 maintains the cabin CO2 levels below safe limits, such as those recommended by The American Society of Heating, Refrigerating and Air-Conditioning Engineers (ASHRAE) Standard 62, to improve driver attention and ensure occupant safety.

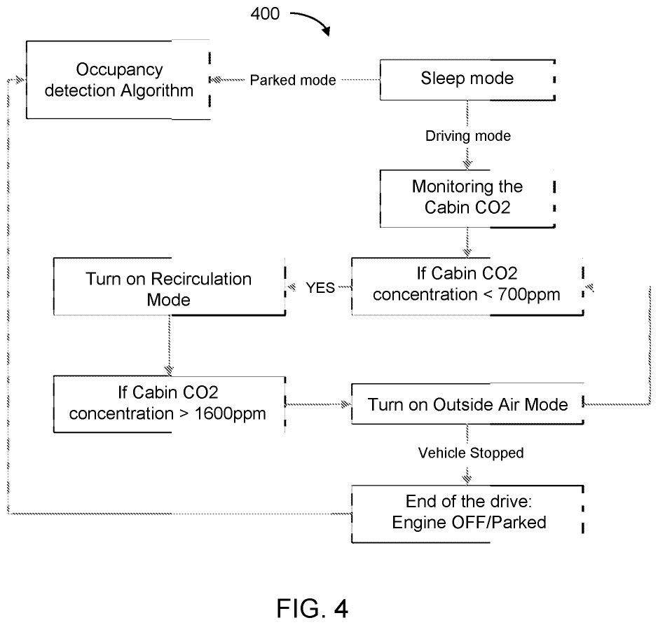

As shown in the flowchart 400 of FIG. 4, when the vehicle is being driven, the cabin monitoring system 20 may also monitor CO2 levels and control the HVAC system 26 to improve energy efficiency of the vehicle. For example, the driving range of electric vehicles decreases in extreme hot or cold environment conditions at least in part because the HVAC system 26 must expend significant amounts of energy to continuously heat or cool the outside air to maintain a comfortable cabin temperature. The cabin monitoring system 20 may shift the HVAC system 26 to activate and deactivate the recirculation feature to improve energy efficiency of the vehicle while maintaining safe CO2 levels within the vehicle. For example, the cabin monitoring system 20 may activate the recirculation feature when CO2 levels are less than a first threshold (such as 700 ppm or less) and only deactivate the recirculation feature if CO2 levels exceed a second threshold (such as 1600 ppm or greater). The cabin monitoring system 20 may cycle the HVAC system 26 between recirculation states to optimize energy efficiency and cabin air safety. Thus, electric powered vehicles equipped with the cabin monitoring system 20 may experience improved driving range and vehicles with combustion engines (e.g., fueled by gasoline or diesel fuel) and equipped with the cabin monitoring system may experience improved fuel economy due to the selective recirculation of the HVAC system 26.

Optionally, to conserve processing power, when the vehicle is being driven, the cabin monitoring system 20 may only process sensor data captured by the CO2 sensing device 24 when the windows and doors are closed because, if any of the door or windows are open, it can be assumed that fresh air is circulating through the cabin of the vehicle and there would not be an elevated CO2 level. Further, when the HVAC system 26 is operating, the system may only operate to determine the CO2 levels present within the vehicle when the HVAC system 26 is operating in the recirculation state as, when the HVAC system 26 is drawing fresh air into the cabin, it can be assumed that fresh air is circulating through the cabin and there would not be an elevated CO2 level.

Optionally, the sensing device 24 may be configured to determine presence or concentration of other substances and compounds within the cabin air of the vehicle, such as pollen, dust, smoke, ethanol, oxygen, and the like. For example, the cabin monitoring system 20 may activate the recirculation feature if air pollutants within the cabin exceed a threshold level of pollutants (which could indicate that the vehicle is being driven through a polluted area). Optionally, the cabin monitoring system 20 may utilize characteristics of the sensing devices and systems described in U.S. patent application Ser. No. 18/353,165, filed Jul. 17, 2023 (Attorney Docket DON01 P4884), which is hereby incorporated herein by reference in its entirety.

Thus, the cabin monitoring system provides a single sensor solution that processes the captured sensor data to provide passive occupant detection to prevent infants, children and animals from being left unattended in a hot vehicle on a sunny day. The cabin monitoring system also maintains CO2 levels below the permissible limit and extends the electric vehicle battery range through controlled ventilation (i.e., changing the cabin circulation mode according to cabin CO2 concentration).

The ECU may comprise a central or single ECU that processes the captured sensor data and image data captured by cameras disposed at the vehicle for a plurality of driving assist functions. The system may utilize aspects of the systems described in U.S. Pat. Nos. 11,242,008; 10,442,360 and/or 10,046,706, and/or U.S. Publication Nos. US-2021-0155167 and/or US-2019-0118717, and/or International Publication No. WO 2022/150826, which are all hereby incorporated herein by reference in their entireties.

The mirror reflective element may include an electro-optic mirror reflective element utilizing characteristics of the interior rearview mirror assemblies described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407; 5,066,112; 6,449,082 and/or 4,712,879, which are hereby incorporated herein by reference in their entireties.

The interior mirror assembly may include a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

Optionally, occupancy of the seat or seats may be determined via processing of image data captured by a cabin-viewing camera of a driver monitoring system or occupant monitoring system. The driver monitoring system or occupant monitoring system may utilize aspects of the systems described in U.S. Pat. Nos. 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2023/034956; WO 2022/241423 and/or WO 2022/187805, and/or PCT Application No. PCT/US2023/021799, filed May 11, 2023 (Attorney Docket DON01 FP4810WO), which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular cabin monitoring system, the vehicular cabin monitoring system comprising:
an air sensing device disposed at a vehicular component, wherein the vehicular component is disposed at an interior portion of a vehicle equipped with the vehicular cabin monitoring system;
wherein the air sensing device captures sensor data representative of a sample of air at the vehicular component;
an electronic control unit (ECU) comprising electronic circuitry and associated software, wherein the electronic circuitry comprises a data processor configured to process sensor data captured by the air sensing device;
wherein the vehicular cabin monitoring system, based on processing at the ECU of sensor data captured by the air sensing device, determines a carbon dioxide level at the interior portion of the vehicle;
wherein the vehicular cabin monitoring system, when the vehicle is parked and not operating and based on the determined carbon dioxide level at the interior portion of the vehicle, determines occupancy of the vehicle; and
wherein the vehicular cabin monitoring system, when the vehicle is operating and based on the determined carbon dioxide level at the interior portion of the vehicle, controls a heating, ventilation, and air conditioning (HVAC) system of the vehicle.

2. The vehicular cabin monitoring system of claim 1, wherein the vehicular component comprises an interior rearview mirror assembly of the vehicle.

3. The vehicular cabin monitoring system of claim 1, wherein the air sensing device comprises a nondispersive infrared (NDIR) sensor.

4. The vehicular cabin monitoring system of claim 1, wherein the vehicular cabin monitoring system, when the vehicle is parked and not operating and based on a determination that the carbon dioxide level at the interior portion of the vehicle is increasing, determines presence of an occupant at the interior portion of the vehicle.

5. The vehicular cabin monitoring system of claim 4, wherein the vehicular cabin monitoring system, when the vehicle is parked and not operating and responsive to determining presence of the occupant at the interior portion of the vehicle, activates an occupancy alert.

6. The vehicular cabin monitoring system of claim 5, wherein the vehicular cabin monitoring system, via processing at the ECU of sensor data captured by a temperature sensor of the vehicle, determines a temperature of the interior portion of the vehicle, and wherein the vehicular cabin monitoring system, activates the occupancy alert responsive to the determined temperature being greater than a first threshold temperature or less than a second threshold temperature that is less than the first threshold temperature.

7. The vehicular cabin monitoring system of claim 6, wherein the vehicular cabin monitoring system, responsive to the temperature being between the first threshold temperature and the second threshold temperature, does not activate the occupancy alert.

8. The vehicular cabin monitoring system of claim 5, wherein the vehicular cabin monitoring system, via processing at the ECU of sensor data captured by a temperature sensor of the vehicle, determines (i) a temperature of the interior portion of the vehicle, and (ii) a rate of change of the temperature of the interior portion of the vehicle, and wherein the vehicular cabin monitoring system, activates the occupancy alert responsive to the determined rate of change being greater than a threshold rate of change.

9. The vehicular cabin monitoring system of claim 1, wherein the vehicular cabin monitoring system, when the vehicle is parked and not operating and based on a determination that the carbon dioxide level at the interior portion of the vehicle is not increasing, determines absence of an occupant at the interior portion of the vehicle.

10. The vehicular cabin monitoring system of claim 9, wherein the vehicular cabin monitoring system, when the vehicle is parked and not operating and responsive to determining absence of the occupant at the interior portion of the vehicle, ceases capturing sensor data with the air sensing device.

11. The vehicular cabin monitoring system of claim 1, wherein the vehicular cabin monitoring system, when the vehicle is operating and responsive to determining that the carbon dioxide level at the interior portion of the vehicle is greater than a first threshold carbon dioxide level, disables a recirculation feature of the HVAC system.

12. The vehicular cabin monitoring system of claim 11, wherein the vehicular cabin monitoring system, when the vehicle is operating and with the recirculation feature of the HVAC system disabled and responsive to determining that the carbon dioxide level at the interior portion of the vehicle is less than a second threshold carbon dioxide level, enables the recirculation feature of the HVAC system, and wherein the second threshold carbon dioxide level is less than the first threshold carbon dioxide level.

13. The vehicular cabin monitoring system of claim 1, wherein the vehicular cabin monitoring system, when the vehicle is operating and responsive to determining that the carbon dioxide level at the interior portion of the vehicle is less than a first threshold carbon dioxide level, activates a recirculation feature of the HVAC system.

14. The vehicular cabin monitoring system of claim 13, wherein the vehicular cabin monitoring system, when the vehicle is operating and with the recirculation feature of the HVAC system activated and responsive to determining that the carbon dioxide level at the interior portion of the vehicle is greater than a second threshold carbon dioxide level, deactivates the recirculation feature of the HVAC system, and wherein the second threshold carbon dioxide level is greater than the first threshold carbon dioxide level.

15. The vehicular cabin monitoring system of claim 1, wherein the vehicle comprises an electric vehicle.

16. The vehicular cabin monitoring system of claim 1, wherein the vehicle comprises a combustion engine.

17. The vehicular cabin monitoring system of claim 1, wherein the vehicular cabin monitoring system, via processing at the ECU of sensor data captured by a temperature sensor of the vehicle, determines a temperature of the interior portion of the vehicle, and wherein the vehicular cabin monitoring system, when the vehicle is parked and not operating and based on the determined temperature of the interior portion of the vehicle being within a range of a threshold temperature, ceases capturing sensor data with the carbon dioxide sensing device.

18. A vehicular cabin monitoring system, the vehicular cabin monitoring system comprising:
an air sensing device disposed at a vehicular component, wherein the vehicular component is disposed at an interior portion of a vehicle equipped with the vehicular cabin monitoring system;
wherein the air sensing device captures sensor data representative of a sample of air at the vehicular component;
an electronic control unit (ECU) comprising electronic circuitry and associated software, wherein the electronic circuitry comprises a data processor configured to process sensor data captured by the air sensing device;
wherein the vehicular cabin monitoring system, based on processing at the ECU of sensor data captured by the air sensing device, determines a carbon dioxide level at the interior portion of the vehicle;
wherein the vehicular cabin monitoring system, when the vehicle is parked and not operating and based on the determined carbon dioxide level at the interior portion of the vehicle, determines occupancy of the vehicle;
wherein the vehicular cabin monitoring system, when the vehicle is parked and not operating and based on a determination that the carbon dioxide level at the interior portion of the vehicle is not increasing, determines absence of an occupant at the interior portion of the vehicle;
wherein the vehicular cabin monitoring system, when the vehicle is parked and not operating and based on a determination that the carbon dioxide level at the interior portion of the vehicle is increasing, determines presence of the occupant at the interior portion of the vehicle;
wherein the vehicular cabin monitoring system, when the vehicle is parked and not operating and responsive to determining presence of the occupant at the interior portion of the vehicle, activates an occupancy alert; and
wherein the vehicular cabin monitoring system, when the vehicle is operating and based on the determined carbon dioxide level at the interior portion of the vehicle, controls a heating, ventilation, and air conditioning (HVAC) system of the vehicle.

19. The vehicular cabin monitoring system of claim 18, wherein the vehicular component comprises an interior rearview mirror assembly of the vehicle.

20. The vehicular cabin monitoring system of claim 18, wherein the air sensing device comprises a nondispersive infrared (NDIR) sensor.

21. The vehicular cabin monitoring system of claim 18, wherein the vehicular cabin monitoring system, when the vehicle is parked and not operating and responsive to determining absence of the occupant at the interior portion of the vehicle, ceases capturing sensor data with the air sensing device.

22. The vehicular cabin monitoring system of claim 18, wherein the vehicular cabin monitoring system, via processing at the ECU of sensor data captured by a temperature sensor of the vehicle, determines a temperature of the interior portion of the vehicle, and wherein the vehicular cabin monitoring system, when the vehicle is parked and not operating and based on the determined temperature of the interior portion of the vehicle being within a range of a threshold temperature, ceases capturing sensor data with the carbon dioxide sensing device.

23. A vehicular cabin monitoring system, the vehicular cabin monitoring system comprising:
an air sensing device disposed at a vehicular component, wherein the vehicular component is disposed at an interior portion of a vehicle equipped with the vehicular cabin monitoring system;
wherein the air sensing device captures sensor data representative of a sample of air at the vehicular component;
an electronic control unit (ECU) comprising electronic circuitry and associated software, wherein the electronic circuitry comprises a data processor configured to process sensor data captured by the air sensing device;
wherein the vehicular cabin monitoring system, based on processing at the ECU of sensor data captured by the air sensing device, determines a carbon dioxide level at the interior portion of the vehicle;
wherein the vehicular cabin monitoring system, when the vehicle is parked and not operating and based on the determined carbon dioxide level at the interior portion of the vehicle, determines occupancy of the vehicle;
wherein the vehicular cabin monitoring system, when the vehicle is operating and based on the determined carbon dioxide level at the interior portion of the vehicle, controls a heating, ventilation, and air conditioning (HVAC) system of the vehicle; and
wherein the vehicular cabin monitoring system, when the vehicle is operating and responsive to determining that the carbon dioxide level at the interior portion of the vehicle is greater than a first threshold carbon dioxide level, disables a recirculation feature of the HVAC system;
wherein the vehicular cabin monitoring system, when the vehicle is operating and with the recirculation feature of the HVAC system disabled and responsive to determining that the carbon dioxide level at the interior portion of the vehicle is less than a second threshold carbon dioxide level, enables the recirculation feature of the HVAC system, and wherein the second threshold carbon dioxide level is less than the first threshold carbon dioxide level; and
wherein the vehicular cabin monitoring system, when the vehicle is operating and responsive to determining that the carbon dioxide level at the interior portion of the vehicle is less than a third threshold carbon dioxide level, activates a recirculation feature of the HVAC system, and wherein the third threshold carbon dioxide level is less than the second threshold carbon dioxide level.

24. The vehicular cabin monitoring system of claim 23, wherein the vehicular component comprises an interior rearview mirror assembly of the vehicle.

25. The vehicular cabin monitoring system of claim 23, wherein the air sensing device comprises a nondispersive infrared (NDIR) sensor.

26. The vehicular cabin monitoring system of claim 23, wherein the vehicular cabin monitoring system, when the vehicle is operating and with the recirculation feature of the HVAC system activated and responsive to determining that the carbon dioxide level at the interior portion of the vehicle is greater than the first threshold carbon dioxide level, deactivates the recirculation feature of the HVAC system.

27. The vehicular cabin monitoring system of claim 23, wherein the vehicular cabin monitoring system, via processing at the ECU of sensor data captured by a temperature sensor of the vehicle, determines a temperature of the interior portion of the vehicle, and wherein the vehicular cabin monitoring system, when the vehicle is parked and not operating and based on the determined temperature of the interior portion of the vehicle being within a range of a threshold temperature, ceases capturing sensor data with the carbon dioxide sensing device.
